(19) United States
(12) Patent Application Publication
(10) Pub. No.: US 2016/0056460 A1
(43) Pub. Date: Feb. 25, 2016

(54) POSITIVE ELECTRODE ACTIVE MATERIAL FOR NON-AQUEOUS ELECTROLYTE SECONDARY CELL, AND NON-AQUEOUS ELECTROLYTE SECONDARY CELL USING SAME

(71) Applicant: SANYO ELECTRIC CO., LTD., Daito-shi, Osaka (JP)

(72) Inventors: Hiroshi Kawada, Osaka (JP); Masahiro Kinoshita, Osaka (JP)

(73) Assignee: SANYO ELECTRIC CO., LTD., Daito-shi, Osaka (JP)

(21) Appl. No.: 14/779,026

(22) PCT Filed: Mar. 6, 2014
(86) PCT No.: PCT/JP2014/001242

§ 371 Date: Sep. 22, 2015

(30) Foreign Application Priority Data
Mar. 25, 2013 (JP) 2013-062336

(51) Int. Cl. H01M 4/505; H01M 2/02; H01M 4/525; C01G 53/00; C01G 51/00

(52) U.S. Cl. CPC H01M 4/505; C01G 53/44; C01G 51/44; H01M 4/525; H01M 2/0222; C01P 2006/40; H01M 2004/028

(57) ABSTRACT

This positive electrode active material for a nonaqueous electrolyte secondary cell includes a lithium-containing transition metal oxide having a layered structure, the principal arrangement of a transition metal, oxygen, and lithium in the positive electrode active material being represented by an O₂ structure. The lithium-containing transition metal oxide: has Li, Mn, Co, and element M in the lithium-containing transition metal layer in the layered structure; and is represented by the general compositional formula Liₓ[Li_{α}(MnₐCo_{b}M_{c})_{1-α}]O₂, where 0.5<x<1.1, 0.1<α<0.33, 0.17<a<0.93, 0.03<b<0.50, and 0.04<c<0.33, the element M including one or more elements selected from the group consisting of Ni, Mg, Ti, Fe, Sn, Zr, Nb, Mo, W, and Bi.

### TECHNICAL FIELD

The present invention generally relates to a positive electrode active material for nonaqueous electrolyte secondary batteries and to a nonaqueous electrolyte secondary battery using the same.

### BACKGROUND ART

As one of the next generation positive electrode active materials, lithium-containing transition metal oxides that belong to space group P6₃mc and have an O2 structure have been studied. In the case where such lithium-containing transition metal oxides are contained as a positive electrode active material, it is expected that the lithium-containing transition metal oxides exhibit a superior charge and discharge property as compared with lithium cobaltate (LiCoO₂) or the like currently put into practical use, which belongs to space group R-3m and has an O3 structure. In Patent Document 1, it is disclosed that the charge and discharge may be conducted even when about 90% of lithium in such lithium-containing transition metal oxides is abstracted. Moreover, in Patent Document 2, it is shown that such lithium-containing transition metal oxides have a high capacity and excellent cyclability by allowing Li, Mn and Co to be contained in a transition metal oxide layer of the lithium-containing transition metal oxides.

### CITATION LIST

### Non Patent Literature

PATENT DOCUMENT 1: Japanese Patent Laid-Open Publication No. 2010-92824
PATENT DOCUMENT 2: Journal of The Electrochemical Society, 146(10), 3560-3565 (1999)

### SUMMARY OF INVENTION

### Technical Problem

A lithium-containing transition metal oxide having an O2 structure is a strong candidate for the next generation positive electrode active material as described above; however, achieving a further higher capacity has been required for putting the lithium-containing transition metal oxide into practical use. It is an advantage of the present invention to provide, in nonaqueous electrolyte secondary batteries containing, as a positive electrode active material, a lithium-containing transition metal oxide in which a principal arrangement is an O2 structure, a positive electrode active material for nonaqueous electrolyte secondary batteries, the positive electrode active material having a high capacity and having a stable charge and discharge property even at a high electric potential.

### Solution to Problem

The positive electrode active material for nonaqueous electrolyte secondary batteries according to the present invention contains a lithium-containing transition metal oxide having a layered structure and a principal arrangement of a transition metal, oxygen, and lithium being represented by an O2 structure, in which the lithium-containing transition metal oxide contains Li, Mn, Co, and an element M in a lithium-containing transition metal layer included in the layered structure, and is represented by a general compositional formula Liₓ[Li_{α}(MnₐCo_{b}M_{c})_{1-α}]O₂, where 0.5<x<1.1, 0.1<α<0.33, 0.17<a<0.93, 0.03<b<0.50, and 0.04<c<0.33, and the element M containing one or more elements selected from the group consisting of Ni, Mg, Ti, Fe, Sn, Zr, Nb, Mo, W, and Bi.

Moreover, the nonaqueous electrolyte secondary battery according to the present invention includes: a positive electrode containing the positive electrode active material for nonaqueous electrolyte secondary batteries; a negative electrode; and a nonaqueous electrolyte.

### Advantageous Effects of Invention

According to the present invention, a nonaqueous electrolyte secondary battery containing, as a positive electrode active material, a lithium-containing transition metal oxide in which a principal arrangement is represented by an O2 structure has a high capacity and has a stable charge and discharge property even at a high electric potential.

### BRIEF DESCRIPTION OF DRAWINGS

FIG. 1 is a schematic view of a coin type battery for evaluation with respect to Examples 1 to 2 and Comparative Examples 1 to 2.

### DESCRIPTION OF EMBODIMENTS

Hereinafter, the embodiment of the present invention will be described in detail. The nonaqueous electrolyte secondary battery that is an example of the present embodiment includes: a positive electrode containing a positive electrode active material; a negative electrode; and a nonaqueous electrolyte containing a nonaqueous solvent. Moreover, a separator is preferably provided between the positive electrode and the negative electrode. The nonaqueous electrolyte secondary battery has, for example, a structure in which an electrode body obtained by rolling or laminating the positive electrode and the negative electrode with the separator interposed therebetween and the nonaqueous electrolyte are housed in a battery exterior body.

[Positive Electrode]

The positive electrode is constituted by, for example, a positive electrode collector such as a metal foil and a positive electrode active material layer formed on the positive electrode collector. A metal foil that is stable within an electric potential range of the positive electrode, a film obtained by arranging, on the surface layer thereof, a metal that is stable within an electric potential range of the positive electrode, or the like is used for the positive electrode collector. Aluminum (Al) is preferably used as the metal that is stable within an electric potential range of the positive electrode. The positive electrode active material layer contains, for example, a conductive agent, a binder, an additive, or the like in addition to the positive electrode active material, and the positive electrode active material layer is a layer obtained by mixing these materials with an appropriate solvent, applying the resultant mixture on the positive electrode collector, and thereafter drying and rolling the applied mixture.

The positive electrode active material contains a lithium-containing transition metal oxide having a layered structure and containing a transition metal, oxygen, and lithium. The details will be described later; however, in a discharged state or an unreacted state, the lithium-containing transition metal oxide is represented by the general compositional formula Liₓ[Li_{α}(MnₐCo_{b}M_{c})_{1-α}]O₂, where 0.5<x<1.1, 0.1<α<0.33, 0.17<a<0.93, 0.03<b<0.50, and 0.04<c<0.33, and M contains one or more elements selected from the group consisting of Ni, Mg, Ti, Fe, Sn, Zr, Nb, Mo, W, and Bi. The present inventors have found that the capacity of the active material is improved by allowing the lithium-containing transition metal oxide to have at least one of the O2 structure, the O6 structure, and the T2 structure and allowing a metal element M to be contained in the lithium-containing transition metal layer included in the layered structure. The supposed reason for this is because the a-axis length in the crystal structure becomes long, as will be described later.

The crystal structure of the lithium-containing transition metal oxide belongs to space group P6₃mc and is specified by the O2 structure. The O2 structure here is a structure in which lithium exists at the center of an oxygen-octahedron, and there are 2 different variations in how oxygen and the transition metal overlap per unit lattice. Such a layered structure has a lithium layer, a lithium-containing transition metal layer, and an oxygen layer. Moreover, it sometimes occurs that a lithium-containing transition metal oxide having the O6 structure and a lithium-containing transition metal oxide having the T2 structure are simultaneously synthesized as by-products in synthesizing the lithium-containing transition metal oxide. The positive electrode active material may contain the lithium-containing transition metal oxide having the O6 structure and the lithium-containing transition metal oxide having the T2 structure synthesized as by-products. In addition, the 06 structure is a structure that belongs to space group R-3m and in which lithium exists at the center of an oxygen-octahedron and there are 6 different variations of how oxygen and the transition metal overlap per unit lattice exist. Moreover, the T2 structure is a structure that belongs to space group Cmca and in which lithium exists at the center of an oxygen-tetrahedron and there are 2 different variations in how oxygen and the transition metal oxide overlap per unit lattice.

Now, in the case where an Li₂MnO₃—LiMO₂ solid solution having a transition metal layer containing Li in the O3 structure as exemplified by lithium cobaltate (LiCoO₂) that is currently put into practical use is used as the positive electrode active material, an improvement in energy density is expected; however, disorder occurs due to movement of Mn ions to an Li ion site associated with charge and discharge to become one factor that brings about deterioration in the battery performance. Such disorder hardly occurs in the O2 structure, the O6 structure, or the T2 structure.

Moreover, the positive electrode active material may contain other metal oxides, etc. that belong to various kinds of space groups in the form of a mixture or a solid solution within a range that does not impair the object of the present invention; however, the lithium-containing transition metal oxide preferably exceeds 50 volume % relative to the total volume of the compounds that constitute the positive electrode active material, more preferably 70 volume % or more.

Furthermore, examples of the other metal oxides include LiCoO₂, which belongs to space group R-3m; Li₂MnO₃ which belongs to space group C2/m or C2/c; and the like.

The lithium-containing transition metal oxide contains Liₓ in the lithium layer included in the layered structure. The lithium-containing transition metal layer contains Li_{α}(MnₐCo_{b}M_{c})_{1-α}, and the oxygen layer contains O₂.

Moreover, the lithium-containing transition metal oxide has compositional ratios (element ratios) of respective elements of 0.5<x<1.1, 0.1<α<0.33, 0.17<a<0.93, 0.03<b<0.50, and 0.04<c<0.33 in the above-described general formula.

When the Li content x in the lithium layer is higher than the above-described range (0.5), the output property may be enhanced. However, when the Li content x is equal to or higher than the above-described range (1.1), it is considered that the amount of residual alkali on the surface of the lithium-containing transition metal oxide becomes large and therefore gelation of slurry during a battery preparation process and lowering of the amount of transition metal that performs oxidation-reduction reaction are brought about, to lower the capacity. Accordingly, x is preferably 0.5 or more and less than 1.1.

The Li content α in the lithium-containing transition metal layer becomes lower as the Mn content and the content of the metal element M become higher. α being equal to or less than the above-described range (0.1) is not preferable from the standpoint of achieving a high capacity, because Li in the lithium-containing transition metal layer contributes to the capacity. On the other hand, when α is equal to or higher than the above-described range (0.33), a stable crystal structure fails to be obtained in the case where the battery is charged to a high electric potential as high as, for example, 4.8 V (vs. Li/Li⁺). It is considered that the stable charge and discharge property may be realized within a range where α is less than 0.33 in the lithium-containing transition metal oxide of the present invention because crystal collapse due to detachment of lithium ions when the electric potential of the positive electrode becomes high is unlikely to occur. Accordingly, α is preferably higher than 0.1 and less than 0.33.

Moreover, the Mn content a being equal to or higher than the above-described range (0.93) is not preferable from the standpoint of achieving a high capacity associated with heightening of the voltage, because the electric potential of the positive electrode tends to be lowered. Furthermore, the content a being equal to or less than the above-described range (0.1) is not preferable because it becomes unlikely to allow lithium that contributes to the capacity of the transition metal layer to be contained and the lithium-containing transition metal layer fails to formed. Accordingly, the content a is preferably higher than 0.1 and less than 0.93.

Moreover, the Co content b being equal to or higher than the above-described range (0.50) is not preferable, from the standpoint of costs. Furthermore, the content b being equal to or lower than the above-described range (0.03) is not preferable, because it becomes hard to allow lithium that contributes to the capacity of the transition metal layer to be contained and the lithium-containing transition metal layer is not formed. Accordingly, the content a is preferably higher than 0.03 and less than 0.50.

Moreover, the a-axis length, which is one of the lattice constants in the crystal structure of the lithium-containing transition metal oxide, may be made long by setting the M content c within the above-described range. It is considered that when the a-axis length becomes long, the movement of lithium between the lithium layer and the lithium-containing transition metal layer is facilitated and therefore a high capacity may be achieved. The M content c is preferably higher than 0.04 and less than 0.33 as a range being effective to make the a-axis length long in the layered structure. Moreover, M is preferably selected from the group consisting of elements that are effective to make the a-axis length long in the layered structure. Such an element is preferably a metal element whose ionic radius is larger than those of Mn and Co. The ionic radius varies depending on the valence number of the metal element M; however, the ionic radius at a valence number of the metal element M that is usable as the positive electrode active material may be larger than those of Mn and Co. Such a metal element is, for example, at least one selected from the group consisting of nickel (Ni), magnesium (Mg), titanium (Ti), iron (Fe), tin (Sn), zirconium (Zr), niobium (Nb), molybdenum (Mo), tungsten (W), and bismuth (Bi). M preferably contains at least Ni.

A method for synthesizing the lithium-containing transition metal oxide is preferably a method in which the corresponding sodium-containing metal oxide is synthesized and thereafter Na in the sodium-containing metal oxide is ion-exchanged with Li. Examples of such a method include a method in which a molten salt bed of at least one lithium salt selected from the group consisting of lithium nitrate, lithium sulfate, lithium chloride, lithium carbonate, lithium hydroxide, lithium iodide, lithium bromide, and lithium chloride is added to a sodium-containing metal oxide. The examples also include a method in which the sodium-containing metal oxide is immersed in a solution containing at least one of the above-described lithium salts. In the lithium-containing transition metal oxide thus prepared, it sometimes occurs that a certain amount of Na is left in the case where the ion-exchange does not completely progress.

The lithium-containing transition metal oxide is preferably obtained by ion-exchanging with lithium a part of sodium contained in the sodium-containing metal oxide represented by Na_{y}[Li_{α}(MnₐCo_{b}M_{c})_{1-α}]O₂ (where 0.5<y<1.1, 0.1<α<0.33, 0.17<a<0.93, 0.03<b<0.50, and 0.04<c<0.33).

The conductive agent is used for enhancing the electric conductivity of the positive electrode active material layer. The conductive agents include carbon materials such as carbon black, acetylene black, Ketjen black, and graphite. These may be used singly or in combinations of two or more. The content of the conductive agent is preferably 0 mass % or more and 30 mass % or less relative to the total mass of the positive electrode active material layer, more preferably 0 mass % or more and 20 mass % or less, particularly preferably 0 mass % or more and 10 mass % or less.

The binder is used for maintaining a favorable contact state between the positive electrode active material and the conductive agent and enhancing the binding property of the positive electrode active material or the like to the surface of the positive electrode collector. As the binder, for example, polytetrafluoroethylene (PTFE), polyvinylidene fluoride, polyvinyl acetate, polymethacrylate, polyacrylate, polyacrylonitrile, polyvinyl alcohol, a mixture of two or more thereof, or the like is used. The binder may be used together with a thickener such as carboxymethyl cellulose (CMC) and a polyethylene oxide. The content of the binder is preferably 0 mass % or more and 30 mass % or less relative to the total mass of the positive electrode active material layer, more preferably 0 mass % or more and 20 mass % or less, particularly preferably 0 mass % or more and 10 mass % or less.

The electric potential of the positive electrode including the above-described constitution at a fully charged state may be made to be as high as 4.3 V (vs. Li/Li⁺) or more based on a lithium metal. The charge finish electric potential of the positive electrode is preferably 4.5 V (vs. Li/Li⁺) or more from the standpoint of achieving a high capacity, more preferably 4.6 V (vs. Li/Li⁺) or more, particularly preferably 4.8 V (vs. Li/Li⁺) or more. The upper limit of the charge finish electric potential of the positive electrode is not particularly limited, but is preferably 5.0 V (vs. Li/Li⁺) or less, from the standpoint of suppressing the decomposition of the nonaqueous electrolyte, or the like.

[Negative Electrode]

The negative electrode includes: for example, a negative electrode collector such as a metal foil; and a negative electrode active material layer formed on the negative electrode collector. As the negative electrode collector, a film or the like obtained by arranging, on the surface thereof, a foil of a metal that hardly forms an alloy with lithium within an electric potential range of the negative electrode or a metal that hardly forms an alloy with lithium within an electric potential range of the negative electrode. As the metal that hardly forms an alloy with lithium within an electric potential range of the negative electrode, copper, which is low cost, easy to process, and has good electric conductivity, is preferably used. The negative electrode active material layer contains, for example, a negative electrode active material, a binder, and the like, and is a layer obtained by mixing these materials with water or an appropriate solvent, applying the resultant mixture on the negative electrode collector, and thereafter drying and rolling the applied mixture.

The negative electrode active material may be used without particular limitation, so long as it is a material capable of intercalating and deintercalating a lithium ion. As such a negative electrode active material, there may be used, for example, carbon materials, metals, alloys, metal oxides, metal nitrides, and carbon and silicon in which alkali metals are intercalated in advance, and the like. The carbon materials include natural graphite, artificial graphite, pitch-based carbon fiber, and the like. Specific examples of the metal or alloy include lithium (Li), silicon (Si), tin (Sn), germanium (Ge), indium (In), gallium (Ga), lithium alloy, silicon alloy, tin alloy, and the like. One negative electrode active material may be used alone, or two or more negative electrode active materials may be used in combination.

As the binder, fluorine based polymers, rubber based polymers, and the like may be used in the same way as in the case of the positive electrode; however, styrene-butadiene copolymers (SBR) being rubber based polymers, the modified products thereof, or the like are preferably used. The binder may be used together with a thickener such as carboxymethyl cellulose.

[Nonaqueous Electrolyte]

The nonaqueous electrolyte contains a nonaqueous solvent, and an electrolyte salt and an additive which are dissolved in the nonaqueous solvent.

The electrolyte salt is a lithium salt that is generally used as a supporting salt in conventional nonaqueous electrolyte secondary batteries. As such a lithium salt, LiPF₆, LiBF₄, LiClO₄, and the like may be used. These lithium salts may be used singly or in combinations of two or more.

The nonaqueous solvent is preferably a fluorine-containing (namely, at least one hydrogen atom is substituted with a fluorine atom) organic solvent, in view that the nonaqueous solvent is resistant to decomposition even though charging is conducted to a high voltage that exceeds, for example, 4.5 V when the nonaqueous solvent is a fluorine-containing organic solvent. As such a fluorine-containing organic solvent, there may be used fluorine-containing cyclic carbonic acid esters, fluorine-containing cyclic carboxylic acid esters, fluorine-containing cyclic ethers, fluorine-containing chain carbonic acid esters, fluorine-containing chain ethers, fluorine-containing nitriles, fluorine-containing amides, and the like. More specifically, fluoroethylene carbonate (FEC), difluoroethylene carbonate (DFEC), trifluoropropylene carbonate (TFPC), and the like may be used as the fluorine-containing cyclic carbonic acid ester, fluoro-γ-butyrolactone (FGBL) and the like as the fluorine-containing cyclic carboxylic acid ester, fluoroethyl methyl carbonate (FEMC), and difluoroethyl methyl carbonate (DFEMC), fluorodimethyl carbonate (FDMC), and the like as the fluorine-containing chain ester.

Among others, 4-fluoroethylene carbonate (FEC) as the fluorine-containing cyclic carbonic acid ester that is a solvent having a high dielectric constant and fluoroethyl methyl carbonate (FEMC) as the chain carbonic acid ester that is a solvent having a low viscosity are preferably mixed and used. The mixing ratio in the case where the solvents are mixed is, for example, FEC:FEMC=1:3 expressed as a volume ratio.

Moreover, an organic solvent not containing fluorine may be used as the nonaqueous solvent. As the organic solvent not containing fluorine, cyclic carbonic acid esters, cyclic carboxylic acid esters, cyclic ethers, chain carbonic acid esters, chain carboxylic acid esters, chain ethers, nitriles, amides, and the like may be used. More specifically, ethylene carbonate (EC), propylene carbonate (PC), and the like may be used as the cyclic carbonic acid ester, γ-butyrolactone (γ-GBL) and the like as the cyclic carboxylic acid ester, and ethyl methyl carbonate (EMC), dimethyl carbonate (DMC), and the like as the chain ester. However, such nonaqueous solvents individually have poor voltage resistance and therefore are preferably used together with the fluorine-containing organic solvent or an additive.

The additive that is added to the nonaqueous electrolyte solution forms an ion permeable coating film on the surface of the positive or negative electrode before the nonaqueous electrolyte solution is subjected to decomposition reaction on the surface of the positive electrode or the surface of the negative electrode, thereby functioning as an agent for forming a surface-coating film that suppresses the decomposition reaction of the nonaqueous electrolyte solution occurring at the surface of the positive or negative electrode. In addition, the surface of the positive or negative electrode here means an interface between the nonaqueous electrolyte solution and the positive electrode active material or negative electrode active material which contribute to the reaction; namely, the surface of the positive electrode active material layer or the negative electrode active material layer and the surface of the positive electrode active material or the negative electrode active material.

As such an additive, vinylene carbonate (VC), ethylene sulfite (ES), cyclohexylbenzene (CHB), ortho-terphenyl (OTP), lithium bis(oxalato)borate (LiBOB), and the like may be used. One additive may be used alone or two or more additives may be used in combination. The ratio of the additive in the nonaqueous electrolyte may be an amount by which the coating film is sufficiently formed and is preferably higher than 0 and 2 mass % or less relative to the total amount of the nonaqueous electrolyte solution.

[Separator]

The separator is a porous film being arranged between the positive electrode and the negative electrode and having ion permeability and insulation property. The porous films include microporous thin films, woven fabric, nonwoven fabric, and the like. As a material used for the separator, polyolefins are preferable, and more specifically, polyethylenes, polypropylenes, and the like are preferable.

### EXAMPLES

Hereinafter, the present invention will be described in more detail by Examples; however, the present invention is not limited to the Examples.

### Example 1

### Preparation of Lithium-Containing Transition Metal Oxide (Positive Electrode Active Material)

Nickel sulfate (NiSO₄), cobalt sulfate (CoSO₄), and manganese sulfate (MnSO₄) were mixed in an aqueous solution so that the stoichiometric ratio was 0.13:0.13:0.74 and coprecipitated to obtain a precursor (Ni, Co, Mn)(OH)₂. Thereafter, the precursor, sodium carbonate (Na₂CO₃), and lithium hydroxide monohydrate (LiOH.H₂O) were mixed so that the stoichiometric ratio was 0.85:0.74:0.15, and the mixture was held at 900° C. for 10 hours to synthesize a sodium-containing transition metal oxide, the main component of which belonged to space group P6₃/mmc and had a P2 structure.

Furthermore, a molten salt bed obtained by mixing lithium nitrate (LiNO₃) and lithium chloride (LiCl) so that the molar ratio was 0.88:0.12 was added by 5 times equivalence (25 g) relative to 5 g of the synthesized product. Thereafter, the mixture was held at 280° C. for 2 hours to thereby ion-exchange a part of the sodium in the sodium-containing transition metal oxide with lithium. Further, the substance after the ion exchange was washed with water to obtain the intended lithium-containing transition metal oxide.

Composition analysis of the obtained lithium-containing transition metal oxide was conducted using an inductively coupled plasma (ICP) emission spectrophotometer (manufactured by Thermo Fisher Scientific K.K., iCAP6300, the same applies hereinafter). It was found from the analysis results that Li:Mn:Co:Ni=0.889:0.625:0.115:0.115 and the detected amount of sodium was the minimum determination limit or lower and therefore sodium was almost completely ion-exchanged with lithium.

Furthermore, the crystal structure of the lithium-containing transition metal oxide was determined. An X-ray powder diffractometer (manufactured by Rigaku Corporation, Powder XRD measurement apparatus RINT2200, radiation source Cu-Kα, the same applies hereinafter) was used for the measurement for analysis, and Rietveld analysis of the obtained diffraction patterns was conducted. As a result of the analysis, the crystal structure was found to be Li_{0.744} [Li_{0.145}Mn_{0.625}Co_{0.115}Ni_{0.115}]O₂ having the O2 structure belonging to space group P6₃mc.

[Preparation of Nonaqueous Electrolyte Solution]

A nonaqueous solvent was obtained by mixing 4-fluoroethylene carbonate (FEC) and fluoroethyl methyl carbonate (FEMC) so that the volume ratio was 1:3. In the nonaqueous solvent, LiPF₆ was dissolved as an electrolyte salt so that the concentration was 1.0 mol/L to prepare a nonaqueous electrolyte solution.

[Preparation of Coin Type Nonaqueous Electrolyte Secondary Battery]

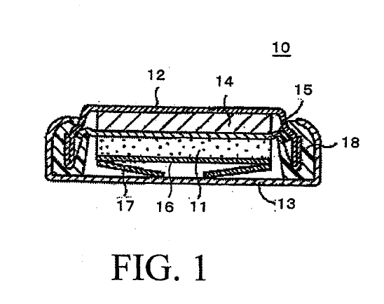

A coin type nonaqueous electrolyte secondary battery (hereinafter, written as coin type battery) for evaluation was prepared by the following procedures. FIG. 1 illustrates a schematic view of the coin type battery 10 used for evaluation. First of all, a lithium-containing transition metal oxide serving as the positive electrode active material, acetylene black serving as the conductive agent, and polyvinylidene fluoride serving as the binder were mixed so that the mass ratio of the positive electrode active material, the conductive agent, and the binder was 80:10:10 to make a slurry using N-methyl-2-pyrrolidone. Next, the slurry was applied on an aluminum foil collector serving as the positive electrode collector and dried in vacuum at 110° C. to prepare a positive electrode 11.

Next, a coin type battery exterior body having a sealing plate 12 and a case 13 was prepared for evaluation, and a lithium metal foil having a thickness of 0.3 mm was adhered as a negative electrode 14 to the inside of the sealing plate 12 under dry air having a dew point of −50° C. or lower. A separator 15 was placed thereon so as to face the negative electrode. The positive electrode 11 was arranged on the separator 15 in such a way that the positive electrode active material layer is opposed to the separator 15. A stiffening plate 16 and a disc spring 17 each made of stainless steel were arranged on the positive electrode collector. The nonaqueous electrolyte solution was injected until the sealing plate 12 was filled, and thereafter the case 13 was put into the sealing plate 12 via a gasket 18 to prepare the coin type battery 10.

### Example 2

In the preparation of the lithium-containing transition metal oxide of Example 1, nickel sulfate (NiSO₄), cobalt sulfate (CoSO₄), and manganese sulfate (MnSO₄) were mixed in an aqueous solution so that the stoichiometric ratio was 0.16:0.16:0.68 and coprecipitated to obtain a precursor (Ni, Co, Mn)(OH)₂. Thereafter, a lithium-containing transition metal oxide was obtained to prepare the coin type battery 10 in the same manner as in Example 1 except that the precursor, sodium carbonate (Na₂CO₃), and lithium hydroxide monohydrate (LiOH.H₂O) were mixed so that the stoichiometric ratio was 0.89:0.74:0.11.

### Example 3

In the preparation of the lithium-containing transition metal oxide of Example 1, nickel sulfate (NiSO₄), cobalt sulfate (CoSO₄), and manganese sulfate (MnSO₄) were mixed in an aqueous solution so that the stoichiometric ratio was 0.05:0.19:0.76 and coprecipitated to obtain a precursor (Ni, Co, Mn)(OH)₂. Thereafter, a lithium-containing transition metal oxide was obtained to prepare the coin type battery 10 in the same manner as in Example 1 except that the precursor, sodium carbonate (Na₂CO₃), and lithium hydroxide monohydrate (LiOH.H₂O) were mixed so that the stoichiometric ratio was 0.85:0.80:0.15.

### Example 4

In the preparation of the lithium-containing transition metal oxide of Example 1, cobalt sulfate (CoSO₄) and manganese sulfate (MnSO₄) were mixed in an aqueous solution so that the stoichiometric ratio was 0.20:0.80 and coprecipitated to obtain a precursor (Co, Mn)(OH)₂. Thereafter, a lithium-containing transition metal oxide was obtained to prepare the coin type battery 10 in the same manner as in Example 1 except that the precursor, sodium carbonate (Na₂CO₃), lithium hydroxide monohydrate (LiOH.H₂O), and titanium oxide (TiO₂) were mixed so that the stoichiometric ratio was 0.78:0.83:0.17:0.05.

### Comparative Example 1

In the preparation of the lithium-containing transition metal oxide of Example 1, cobalt sulfate (CoSO₄) and manganese sulfate (MnSO₄) were mixed in an aqueous solution so that the stoichiometric ratio was 0.35:0.65 and coprecipitated to obtain a precursor (Co, Mn)(OH)₂. Thereafter, a lithium-containing transition metal oxide was obtained to prepare the coin type battery 10 in the same manner as in Example 1 except that the precursor, sodium carbonate (Na₂CO₃), and lithium hydroxide monohydrate (LiOH.H₂O) were mixed so that the stoichiometric ratio was 0.89:0.70:0.11.

### Comparative Example 2

In the preparation of the lithium-containing transition metal oxide of Example 1, cobalt sulfate (CoSO₄) and manganese sulfate (MnSO₄) were mixed in an aqueous solution so that the stoichiometric ratio was 0.20:0.80 and coprecipitated to obtain a precursor (Co, Mn)(OH)₂. Thereafter, a lithium-containing transition metal oxide was obtained to prepare the coin type battery 10 in the same manner as in Example 1 except that the precursor, sodium carbonate (Na₂CO₃), and lithium hydroxide monohydrate (LiOH.H₂O) were mixed so that the stoichiometric ratio was 0.92:0.65:0.08.

### Comparative Example 3

In the preparation of the coin type battery 10 of Example 1, nickel sulfate (NiSO₄), cobalt sulfate (CoSO₄), and manganese sulfate (MnSO₄) were mixed in an aqueous solution so that the stoichiometric ratio was 0.16:0.16:0.68 and coprecipitated to obtain a precursor (Ni, Co, Mn)(OH)₂. Thereafter, the coin type battery 10 was prepared in the same manner as in Example 1 except that the precursor and lithium hydroxide monohydrate (LiOH.H₂O) were mixed so that the stoichiometric ratio was 0.8:1.2, and the mixture was held at 900° C. for 10 hours to prepare and use, as the positive electrode active material, Li [Li_{0.200}Mn_{0.533}Co_{0.133}Ni_{0.133}]O₂ belonging to space group R-3m and having the O3 structure.

In addition, composition analysis and analysis of the crystal structure of the lithium-containing transitional metal oxides obtained in Examples 2 and Comparative Example 1 were conducted by the ICP emission spectrophotometric analysis in the same manner as in Example 1. The results are shown in Table 1 together with the results of Example 1.

[Confirmation of a-Axis Length]

With respect to Examples 1 to 2 and Comparative Example 1, the powder X-ray diffraction measurement was conducted for the purpose of confirming that the a-axis length was extended by allowing Ni to be contained in the lithium-containing transition metal oxide as the element M. The lattice constant was calculated from the obtained diffraction pattern to determine the a-axis length.

[Evaluation of Capacity of Active Material]

With respect to Examples 1 to 2 and Comparative Example 1, charging was conducted at a constant current of 0.05 C until the electric potential of the positive electrode reached 4.6 V (vs. Li/Li⁺) based on a lithium metal, and thereafter charging was further conducted at a constant voltage until the current value reached 0.02 C. Thereafter, discharging was conducted at a constant current of 0.05 C until the electric potential of the positive electrode reached 3.0 V (vs. Li/Li⁺). A value obtained by dividing the discharging capacity at that time by the total mass of the positive electrode active material contained in the positive electrode was determined as the capacity of the active material.

With respect to Examples 1 to 2 and Comparative Example 1, the composition, the a-axis length, and the capacity of the active material are shown together in Table 1.

TABLE 1

| | | | a-Axis | Capacity of |
|---|---|---|---|---|
| | | | length | active material |
| | Structure | Composition | (nm) | (mAh/g) |
| Example 1 | O2 | Li_{0.744}[Li_{0.145}Mn_{0.625}Co_{0.115}Ni_{0.115}]O₂ | 0.28303 | 254.7 |
| Example 2 | O2 | Li_{0.743}[Li_{0.105}Mn_{0.597}Co_{0.149}Ni_{0.149}]O₂ | 0.28329 | 221.0 |
| Example 3 | O2 | Li_{0.802}[Li_{0.148}Mn_{0.648}Co_{0.162}Ni_{0.043}]O₂ | 0.28284 | 266.1 |
| Example 4 | O2 | Li_{0.833}[Li_{0.165}Mn_{0.635}Co_{0.159}Ti_{0.043}]O₂ | 0.28264 | 248.2 |
| Comparative | O2 | Li_{0.697}[Li_{0.114}Mn_{0.579}Co_{0.307}]O₂ | 0.28102 | 199.5 |
| Example 1 | | | | |
| Comparative | O2 | Li_{0.651}[Li_{0.078}Mn_{0.747}Co_{0.175}]O₂ | 0.28216 | 162.1 |
| Example 2 | | | | |
| Comparative | O3 | Li [Li_{0.200}Mn_{0.533}Co_{0.133}Ni_{0.133}]O₂ | — | 178.4 |
| Example 3 | | | | |

From Table 1, the a-axis length is longer in Examples 1 to 2 as compared with the a-axis length in Comparative Example 1, and the obtained capacity of the active material in Examples 1 to 2 was as high as in excess of 220 mAh/g. That is to say, it was confirmed that the lithium-containing transition metal oxide exhibited the effects of extending the a-axis length and improving the capacity of the active material by allowing Ni to be contained in the lithium-containing transition metal oxide as the metal element M. It is considered that achieving a high capacity for the positive electrode active material in the present invention as described above was a result of allowing Ni to be contained in the lithium-containing transition metal oxide serving as a positive electrode active material, thereby extending the a-axis length to be a moving path of lithium during discharge to facilitate the movement of Li between layers of the lithium layer and the lithium-containing transition metal layer. It is inferred that such effect may also be obtained by another element that extends the a-axis length by the addition thereof. Such element is an element having a larger ion radius than that of Mn, and examples thereof are at least one or more elements selected from the group consisting of Mg, Ti, Fe, Sn, Zr, Nb, Mo, W, and Bi.

Moreover, the capacity of the active material in the O2 structure was larger than in the case where Ni was added (Comparative Example 3) in the O3 structure, and it is understood that the effect of improving the capacity of the active material due to the expansion of the a-axis length in the O2 structure exceeds the effect obtained by the conventional Ni addition.

From the above, by applying, to the positive electrode active material, the lithium-containing transition metal oxide having the O2 structure; containing, in the lithium-containing transition metal layer included in the layered structure, Li, Mn, and Co, and the element M exhibiting the effect of extending the a-axis length; and represented by the general compositional formula Liₓ[Li_{α}(MnₐCo_{b}M_{c})_{1-α}]O₂, where 0.5<x<1.1, 0.1<α<0.33, 0.17<a<0.93, 0.03<b<0.50, and 0.04<c<0.33, and M represents at least one or more elements selected from the group consisting of Ni, Mg, Ti, Fe, Sn, Zr, Nb, Mo, W, and Bi, there may be obtained the effect that the charge and discharge at a high electric potential is made possible and further the effect that the movement of Li is facilitated to increase the capacity.

### REFERENCE SIGNS LIST

10 Coin type battery
11 Positive electrode
12 Sealing plate
13 Case
14 Negative electrode
15 Separator
16 Stiffening plate 16
17 Disc spring
18 Gasket

1. A positive electrode active material for a nonaqueous electrolyte secondary battery, comprising a lithium-containing transition metal oxide having a layered structure and a principal arrangement of a transition metal, oxygen, and lithium being represented by an O2 structure, wherein the lithium-containing transition metal oxide comprises Li, Mn, Co, and an element M in a lithium-containing transition metal layer included in the layered structure, and is represented by a general compositional formula Liₓ[Li_{α}(MnₐCo_{b}M_{c})_{1-α}]O₂, where 0.5<x<1.1, 0.1<α<0.33, 0.17<a<0.93, 0.03<b<0.50, and 0.04<c<0.33, and the element M comprising one or more elements selected from the group consisting of Ni, Mg, Ti, Fe, Sn, Zr, Nb, Mo, W, and Bi.

2. The positive electrode active material for nonaqueous electrolyte secondary batteries according to claim 1, further comprising a lithium-containing transition metal oxide represented by at least one of an O6 structure and a T2 structure.

3. The positive electrode active material for nonaqueous electrolyte secondary batteries according to claim 1, wherein the lithium-containing transition metal oxide is obtained by ion-exchanging with lithium a part of sodium contained in a sodium-containing oxide represented by Na_{y}[Li_{α}(MnₐCo_{b}M_{c})_{1-α}]O₂, where 0.5<x<1.1, 0.1<α<0.33, 0.17<a<0.93, 0.03<b<0.50, and 0.04<c<0.33.

4. A nonaqueous electrolyte secondary battery, comprising:
a positive electrode comprising a positive electrode active material;
a negative electrode, and
a nonaqueous electrolyte,
wherein the positive electrode active material comprises a lithium-containing transition metal oxide having a layered structure and a principal arrangement of a transition metal, oxygen, and lithium being represented by an O2 structure,
the lithium-containing transition metal oxide comprising Li, Mn, Co, and an element M in a lithium-containing transition metal layer included in the layered structure, and being represented by a general compositional formula Liₓ[Li_{α}(MnₐCo_{b}M_{c})_{1-α}]O₂, where 0.5<x<1.1, 0.1<α<0.33, 0.17<a<0.93, 0.03<b<0.50, and 0.04<c<0.33, and the element M comprising one or more elements selected from the group consisting of Ni, Mg, Ti, Fe, Sn, Zr, Nb, Mo, W, and Bi.

5. The nonaqueous electrolyte secondary battery according to claim 4, wherein the positive electrode has a charge finish electric potential of 4.5 V or more and 5.0 V or less (vs. Li/Li⁺).
